(19) United States
(12) Patent Application Publication
(10) Pub. No.: US 2005/0016091 A1
(43) Pub. Date: Jan. 27, 2005

(54) Tenon-snap joint structure for glass panel mounting frames

(76) Inventor: Kuei Yung Wang Chen, Taipei (TW)

Correspondence Address: STEVENS, DAVIS, MILLER & MOSHER, L.L.P., Suite 850, 1615 L Street, N.W., Washington, DC, 20036, US

(21) Appl. No.: 10/622,426

(22) Filed: Jul. 21, 2003

(51) Int. Cl. E06B 3/00

(52) U.S. Cl. 52/204.1; 52/204.5

(57) ABSTRACT

The invention is a tenon-snap joint structure for glass panel mounting frames designed for mounting glass on door leaf, which tenon-snap structure of the glass panel mounting frames is formed by plural number of male and female tenon-snap piece located on the reverse side of the glass panel mounting frame, and when two identical glass panel mounting frames are packed for transport, one glass panel mounting frame shall be positioned by rotating an angle of 180 degrees with respect to the other glass panel mounting frame, and then turned over to have it stacked on the other glass panel mounting frame to have the packing volume substantially reduced for transport.

### BACKGROUND OF THE PRESENT INVENTION

1. Field of the Present Invention

The invention relates to a tenon-snap joint structure for glass panel mounting frame, and more specifically to the glass panel mounting frame substantially to minimize the packing volume for transport.

2. Description of Prior Art

Presently, the door leaf structure with glass panel commonly used is shown in FIG. 1 in which the structure comprises two pieces of glass panel frames (11) which are mounted on the front and reverse side of the door leaf (10) to fix the glass panel (12) on door leaf (10) and bear the weight of the glass panel (12).

As for the commonly used glass panel mounting frame (11) referred to in the above there are two basic types of structure, one of them is the traditional glass panel frames without tenon joint structure (11) which can be used for mounting glass panel on door leaf (10) by applying the fastening means such as screws; another type is the glass panel frames having tenon joint structure (11) which can be mounted, and snap on the front and reverse side of the door leaf (10) directly by tenon joint piece without the needs of fastening screws. This type of glass panel mounting frame largely outstrips those traditional types of glass panel mounting frame without tenon joint (11) in the convenience of installation, and has become the main trend of the market.

In view of this, those who are dealing with the related business or the development of the related products all focus their attention on how to develop a new type of tenon joint structure which can achieve an easier and more convenient installation of glass panel on door leaf by means of using two pieces of mounting frames which can be jointed together through tenon joint structure.

In addition, since the glass panel mounting frame (11) equipped with tenon-snap joint structure, this type of glass panel mounting frames have difficulty in packing, and cause waste of transport space due to its enlarged packing volume. Therefore, how to reduce the packing volume of the glass panel frames to save transportation cost and how to develop a new type of tenon joint structure both have a close bearing on each other.

### SUMMARY OF THE PRESENT INVENTION

The major purpose of the invention is to provide a snap-joint structure of the tenon-joint on the reverse side of the glass panel mounting frame which enables two pieces of glass panel mounting frame to snap and joint with each other simply and easily to form an integral unit and achieve the effect of time saving and cost reduction when mounting glass panel on door leaf.

Another purpose of the invention is to provide a position arrangement of the male and female tenon-snap piece located on the reverse side of the mounting frame which can minimize the packing volume of the mounting frames when they are stacked together for transport so as to achieve the most effective packing and transportation as well as the reduction of transportation cost.

### BRIEF DESCRIPTION OF THE DRAWING FIGURES

FIG. 1 is the appearance and structure drawing of the commonly used door leaf with glass panel.

FIG. 2 is the structure drawing of the glass panel mounting frame of the invention.

FIG. 3 is the plan view of two glass panel mounting frames with tenon-snap joint of the invention placed in a position that one of them is ready for being turned over and jointed to the other frame.

FIG. 4 is showing that two glass panel mounting frames of the invention are ready to be jointed together. The male and/or the female tenon-snap piece on one frame are aligned with and set into the respective female and male tenon-snap piece.

FIG. 5 is the plan view of the glass panel mounting frames with tenon-snap joint of the invention placed in a position in which one of the mounting frame is rotated an angle of 180 degrees and is ready for being turned over and stacked on another mounting frame.

FIG. 6 is an aspect view of the two glass panel mounting frames of the invention in stacking configuration which shows that the packing volume can be minimized.

FIG. 7 is the construction and assembling view of the tenon-snap joint structure formed by the male (43) and female (46) tenon-snap piece of the invention.

FIG. 8 is the explosion view showing the assembly of the two glass panel mounting frames with tenon-snap joint of the invention, the glass panel and the door leaf.

FIG. 9 is the partial cross sectional view of the invention showing the application of the two glass panel mounting frames with tenon-snap joint of the invention to install and mount glass panel on a door leaf.

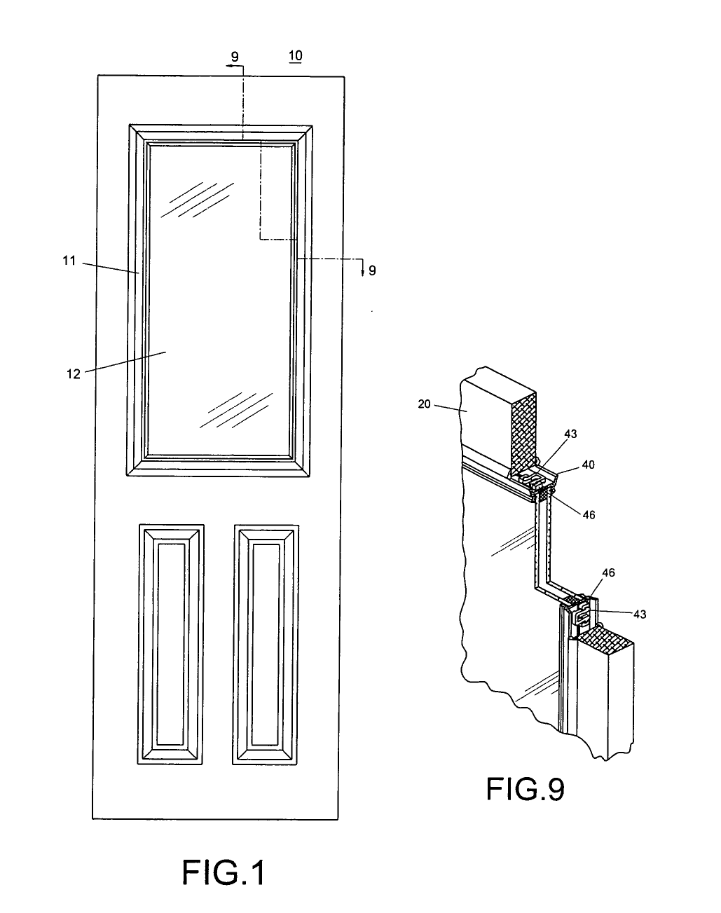

### DETAILED DESCRITION OF THE PREFERRED EMBODIMENTS

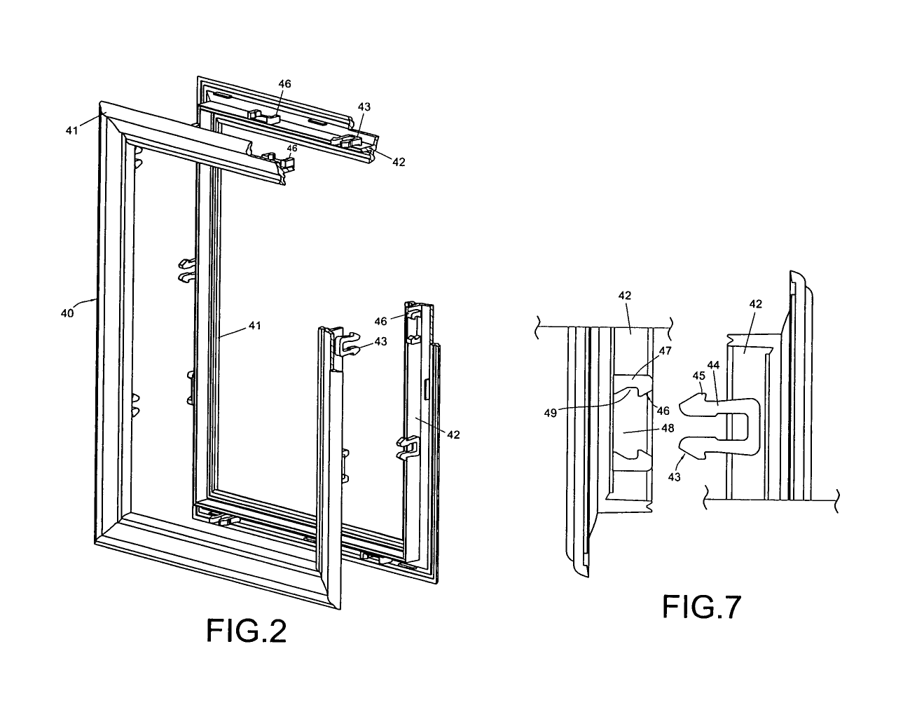

This invention is disclosed a mounting glass panel (40) which has a quadrilateral frame (41) with tenon-snap joint structure as shown in FIG. 2. The appearance of the mounting glass panel (40) may be in square, rectangular, circular, elliptic, or semi-circular shape or other kinds of geometric shape. The quadrilateral frame (41) provides a ring-like rib plate (42) which has a definite height and contour parallel to the outer contour of the quadrilateral frame (41), and on outer peripheral sides of the said ring-like rib plate (42) there are several protruding male tenon-snap pieces (43) and protruding female tenon-snap pieces (46) are integrally formed and positioned in such a way that the position of those tenon-snap pieces shall be arranged in the manner of male tenon-snap pieces (43) adjoining male tenon-snap pieces (43), or male tenon-snap pieces (43) adjoining female tenon-snap pieces (46), or female tenon-snap pieces (46) adjoining female tenon-snap pieces (46) with proper space between them.

As in brief, the layout of position of the said male tenon-snap piece (43) and female tenon-snap piece (46) arranged along the outer peripheral surface of the whole ring-like rib plate (42), and the tenon-snap joint structure formed by the said male tenon-snap piece (43) and female tenon-snap piece (46), are the focal point of the invention.

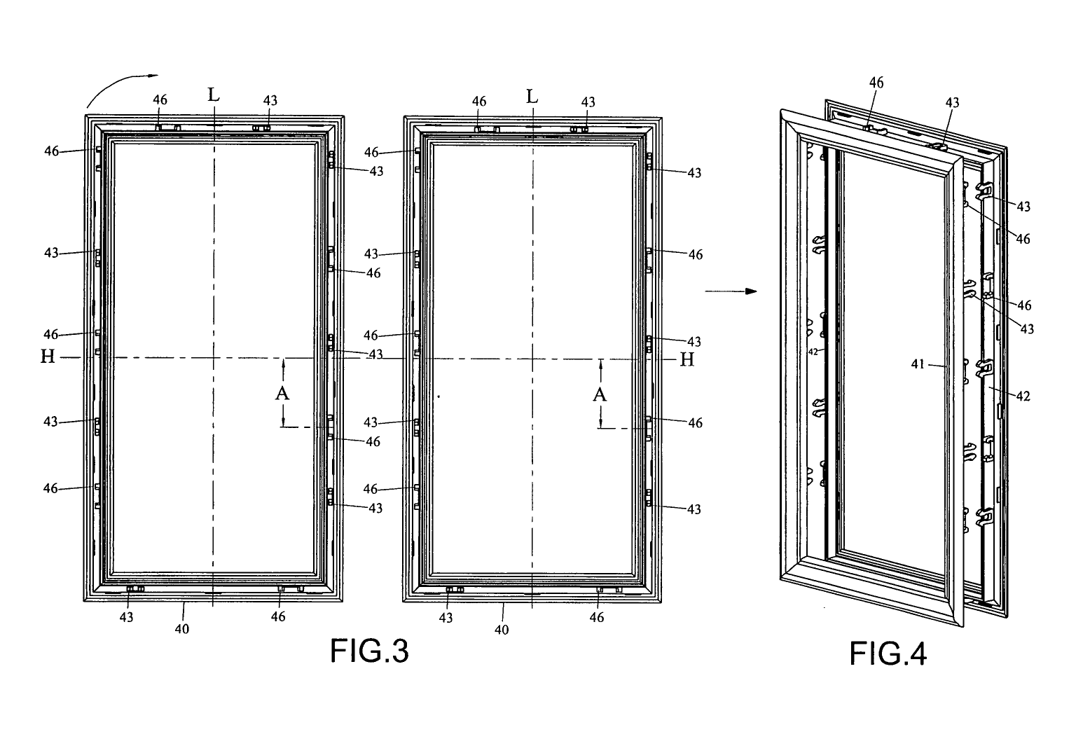

The glass panel mounting frame (40) of the invention is shown in FIG. 3 on which the male tenon-snap piece (43) and female tenon-snap piece (46) are arranged in such a way that the position of male tenon-snap piece (43) and/or female tenon-snap piece (46) on the left and right side of the right rib plate (42) are symmetric to each other with respect to the longitudinal center line L, while based on the holizontal center line H all the male tenon-snap pieces (43) and female tenon-snap pieces (46) on the vertical portion of the ring-like rib plate (42) are shifted an offset distance A with respect to the horizontal center line H.

In other words, based on the geometric center line of the glass panel mounting frame (40), if a male tenon-snap piece (43) is located at a position on the left side of the ring-like rib plate (42), then a female tenon-snap piece (46) must be located at the symmetric position on the right side of the ring-like rib plate (42) with respect to the longitudinal center line L.

Whereas, if a female tenon-snap piece (46) is located at a position on the left side of the ring-like rib plate (42), then a male tenon-snap piece (43) must be located at the symmetric position on the right side of the ring-like rib plate (42) with respect to the longitudinal center line L.

With this, two identical glass panel mounting frame (40), if placed in a position as shown in FIG. 3, can be assembled with each other to form a complete unit as shown in FIG. 4, while the male tenon-snap piece (43) and the female tenon-snap piece (46) on one of the two glass panel mounting frames (40) can be jointed to and snapped into the respective female tenon-snap piece (46) and male tenon-snap piece (43) on the other glass panel mounting frames (40) to form a complete set of mounting frames (40) capably to be mounted on door leaf.

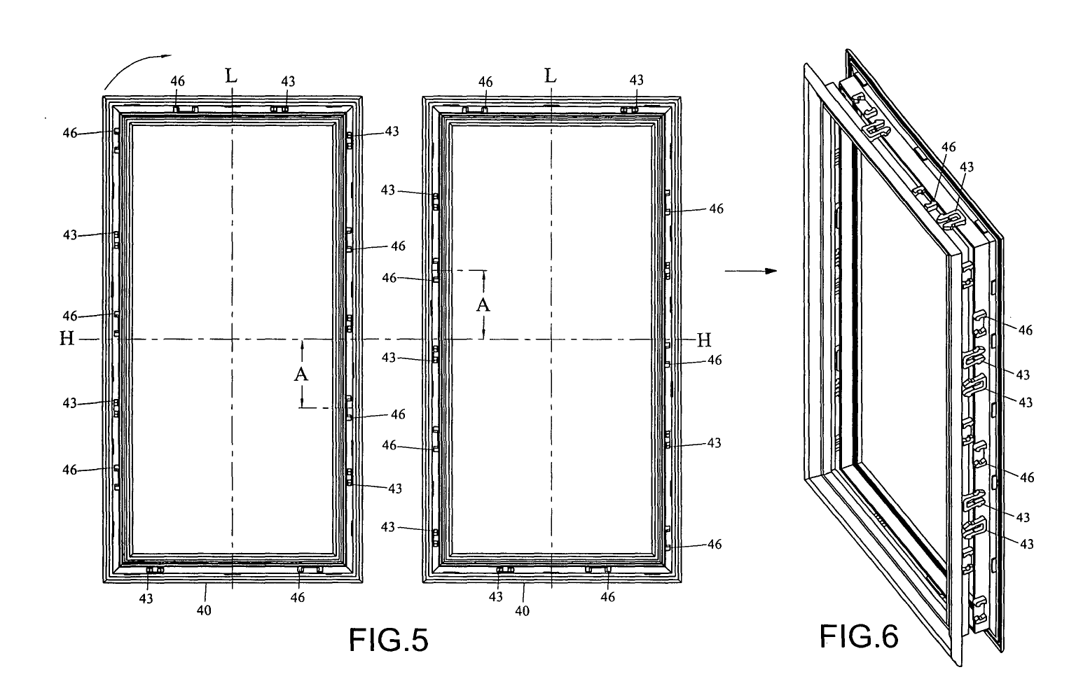

Furthermore, the purpose of shifting the male tenon-snap piece (43) and/or the female tenon-snap piece (46) on the vertical portion of the ring-like rib plate (42) an offset distance A with respect to the horizontal center line H is to reduce the packing volume during transport. The procedure is as follows; referring to FIG. 5 and FIG. 6, before packing the glass panel mounting frames (40), one of the glass panel mounting frames (40) is rotated an angle of 180 degrees, and then turned over to lay on the other glass panel mounting frame (40), this enables male tenon-snap piece (43) and/or the female tenon-snap piece (46) on the ring-like rib plate (42) of a glass panel mounting frames (40) to fall exactly into the space between the male tenon-snap piece (43) and/or the female tenon-snap piece (46) on the ring-like rib plate (42) of the other glass panel mounting frames (40) without interference to each other that enables the top surface of the two ring-like rib plates to closely touch each other when two pieces of the frame of the invention are stacked together for transport.

By this way not only a smooth and plain surface can be obtained to facilitate packing but also a minimized packing volume can be obtained by reducing the thickness of packing size that can minimize the packing volume, and achieve the most effective packing and transportation.

The detailed structure of the male tenon-snap piece (43) and the female tenon-snap piece (46) of the invention are shown in FIG. 2 and FIG. 7, i.e. the male tenon-snap piece (43) has a pair of snap ribs (44) formed apart from each other with proper space between them. The lower part of the snap rib (44) is built to the outer surface of the ring-like rib plate (42) of the glass panel mounting frame (40) while the upper part of the snap rib (44) protrude a proper height over the edge of the ring-like rib plate (42), this enables the upper part of the snap rib (44) to have a proper elasticity. Further, on the upper end of the snap rib (44) a reverse catch (45) is formed and extended outwardly to enable the pair of snap rib (44) to act as a spring buckle, which formed as the structure for jointing the male tenon-snap piece (43) to the female tenon-snap piece (46).

However, the female tenon-snap piece (46) also has a pair of snap ribs (47) formed apart from each other with proper space between them. The said snap ribs (47) are integrally built to the outer surface of the ring-like rib plate (42) of the glass panel mounting frame (40) which form a snap slot (48) with the ring-like rib plate and improves the stiffness of the female tenon-snap piece (46) to facilitate the joint with the male tenon-snap piece (43). In addition, inside the snap slot (48) formed by the snap ribs (47) is recessed a recess (49) on the inner edge of female tenon-snap piece (46), with this structure two identical glass panel mounting frames (40) of the invention can be firmly jointed together to form a complete unit.

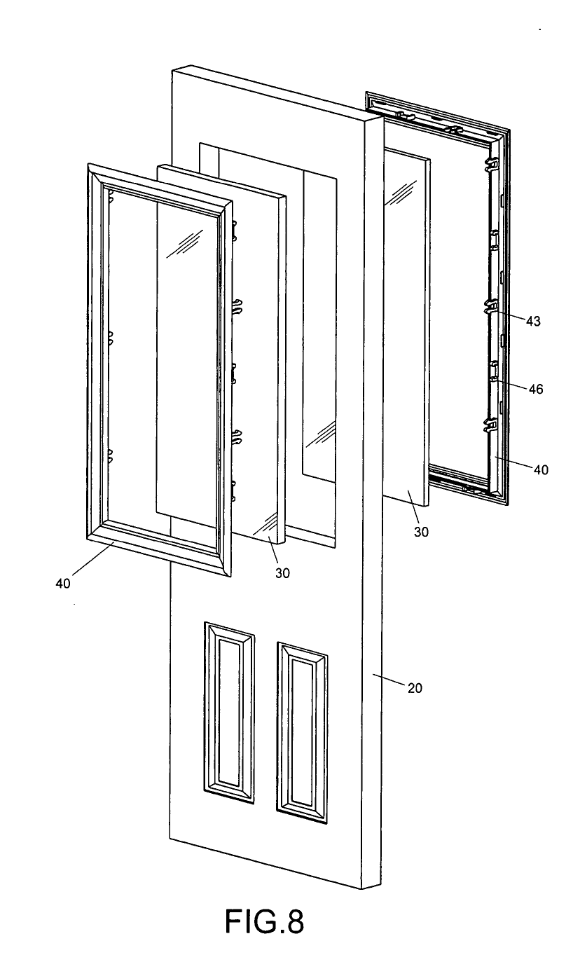

Referring to FIG. 8 and FIG. 9, the two identical glass panel mounting frames (40) of the invention can be jointed together through its tenon-snap piece from the front and reverse side of door leaf (20) to sandwich one or more than one glass (30) and mount the glass (30) on door leaf (20). Since two identical glass panel mounting frames (40) of the invention can be firmly connected and jointed together as an integral structure it possesses the structural strength sufficiently for bearing the weight of glass (30).

And, since the male tenon-snap piece (43) and the female tenon-snap piece (46) on one of the glass panel mounting frames (40) can easily snap into the female tenon-snap piece (46) and the male tenon-snap piece (43) on the other glass panel mounting frame (40) it can easily and quickly install and mount the glass (30) on door leaf (20) that achieves the effect of saving installation time and reducing manufacturing cost.

Further referring to FIG. 6, when one glass panel mounting frame (40) of the invention is piled on the other as shown in FIG. 6, the packing volume is minimized that can achieve the most effective packing, transportation, as well as the reduction of transportation cost.

1. A tenon-snap joint structure for glass panel mounting frame comprises a ring-like rib plate on which outer surface have arranged several protruding male tenon-snap pieces and female tenon-snap pieces, wherein when taking the longitudinal center line L of the glass panel mounting frame as the basis, each protruding male/female tenon-snap piece arranged on left side vertical portion of the ring-like rib plate are positioned symmetrically to the protruding female/male tenon-snap piece arranged on right side vertical portion of the ring-like rib plate on right side with respect to the said longitudinal center line, and when taking the horizontal center line H of the glass panel mounting frame as the basis all the protruding male tenon-snap piece and/or the protruding female tenon-snap piece on the vertical portion of the ring-like rib plate are shifted an offset distance A with respect to the said horizontal center line H.

2. The tenon-snap joint structure as defined in claim 1, wherein the said protruding male tenon-snap piece has a pair of male snap ribs on which upper end is extended outwardly a protruded snap catch, and the said protruding female tenon-snap piece has a pair of female snap ribs which form a snap slot with the ring-like rib plate, and within the said snap slot each female snap ribs are respectively provided with a recess.

3. The tenon-snap joint structure as defined in claim 2, wherein two identical glass panel mounting frames are jointed as a complete unit by having each protruding male/female tenon-snap piece of one of the two glass panel mounting frames snapped into the respective protruding female/male tenon-snap piece of another glass panel mounting frame.

4. The tenon-snap joint structure as defined in claim 2, wherein one of two identical glass panel mounting frames is rotated an angle of 180 degrees, and turned over to have it stacked on another glass panel mounting frame, the respective top surface of ring-like rib plates of the two identical glass panel mounting frames are closely touched each other.
